(19) United States
(12) Patent Application Publication
(10) Pub. No.: US 2024/0190169 A1
(43) Pub. Date: Jun. 13, 2024

(54) Wheel for a Chassis of a Rail Vehicle, Chassis for Rail Vehicles and Method for Producing the Wheel for the Chassis of the Rail Vehicle

(71) Applicant: Siemens Mobility Austria GmbH, Wien (AT)

(72) Inventors: Johannes KRASA, Irdning-Donnersbachtal (AT); Gerd LÖFFLER, Empersdorf (AT); Franz-Josef WEBER, Graz (AT)

(21) Appl. No.: 18/287,901

(22) PCT Filed: Apr. 20, 2022
(86) PCT No.: PCT/EP2022/060349

§ 371 Date: Oct. 23, 2023

(30) Foreign Application Priority Data
Apr. 23, 2021 (AT) A 50304/2021

(51) Int. Cl. B60B 17/00

(52) U.S. Cl. CPC B60B 17/0006

(57) ABSTRACT

A forged wheel for a chassis of a rail vehicle includes a wheel web, a wheel hub and a wheel rim with a running surface and a wheel flange, where material is recessed out of the wheel web, which is solid in sections, between the wheel hub and the wheel rim, in sections extending in the circumferential direction or transversely with respect to a radial direction of the wheel web, and where at least a first distance and a second distance between a recess centre point of a first recess in the wheel web and an edge of the first recess differ in size such that a lightweight wheel that can be manufactured with little outlay and that has high strength and quality is obtained.

### CROSS-REFERENCE TO RELATED APPLICATIONS

This is a U.S. national stage of application No. PCT/EP2022/060349 filed 10 Apr. 2022. Priority is claimed on Austrian Application No. A50304/2021 filed 23 Apr. 2021, the content of which is incorporated herein by reference in its entirety.

### BACKGROUND OF THE INVENTION

### 1. Field of the Invention

The invention relates to a wheel for a chassis of a rail vehicle, comprising a wheel web, a wheel hub and a wheel rim with a running surface and a wheel flange.

### 2. Description of the Related Art

Various types of wheels for chassis of rail vehicles are known from the prior art. These include solid wheels, wheels with wheel bodies and wheel tires associated therewith, spoked wheels and hollow wheels with recesses. Solid wheels or wheel bodies often have solid wheel webs, which can be designed as straight or corrugated. The wheels can be connected via wheel hubs, for example, to wheelset shafts (for a chassis with wheelsets) or stub axles or wheel bridges (for a chassis with idler gear pairs or idler gear sets).

Wheels for chassis of rail vehicles can, for example, be designed as cast wheels, but also as forged wheels. In particular, solid wheels often have a large mass, which causes high unsprung masses and heavy wear and tear on wheels and tracks as well as high levels of noise pollution.

WO 2016/173749 A1, for example, shows a solid wheel for a rail vehicle with a spoke-like structure. Arranged between a wheel rim and a wheel hub are an end wall and a rear wall, between which a vault-like cavity is formed. The end wall and the rear wall have openings, resulting in the spoke-like structure of the solid wheel.

U.S. Pat. No. 2,609,229 A shows a cast spoked wheel for locomotives, in which a plurality of spokes are arranged between a wheel hub and a wheel rim, aligned in a star shape from the wheel hub to the wheel rim.

Furthermore, WO 2018/197581 A1 shows a modular vehicle wheel, with teeth being provided between a wheel hub and a wheel web formed in a straight manner. Here, the wheel web is solid and has holes for connecting friction rings of a wheel brake disk to the vehicle wheel.

The disadvantage of the conventional approaches is that they have a large mass or require a great deal of manufacturing effort to form and arrange the spoked structure or the spokes.

### SUMMARY OF THE INVENTION

In view of the foregoing, it is therefore an object of the invention to provide a wheel with reduced mass that is developed further in comparison to prior art wheels and that is easy to manufacture.

This and other objects and advantages are achieved in accordance with the invention by a wheel formed as a forged wheel, wherein material is recessed out of the wheel web, which is solid in sections, between the wheel hub and the wheel rim, in sections extending in the circumferential direction or transversely with respect to a radial direction of the wheel web, and where at least one first distance and one second distance between a recess center point of a first recess in the wheel web and an edge of the first recess differ in size.

As a result, an advantage is achieved in terms of mass, similarly as in the case of a spoked wheel, but with significantly less manufacturing effort. Owing to the advantage in terms of mass or a reduction in mass, a reduction in unsprung masses on a rail vehicle and a reduction in wear and tear on the wheel itself and on a track is effected. Owing to the reduction in mass, acoustic properties of the rail vehicle are also improved and noise pollution is reduced.

A wheel with a solid wheel web can be used as the basis for this, from which material can be recessed or removed in one manufacturing step.

The material is recessed extending in the circumferential direction or transversely with respect to a radial direction of the wheel web. Material recesses can be provided both for solid wheels and for wheels with wheel bodies and wheel tires detachably connected to the wheel bodies. The wheel web can be formed as straight or else as corrugated.

The material recesses can have various three-dimensional contours optimized for mass, strength and/or sound emissions. The first recess can, for example, have a rectangular or trapezoidal shape with rounded corners, an oval shape, an elliptical shape or a circular ring sector shape, etc. This results in a high level of strength for the inventive wheel. Acoustic properties of the inventive wheel can be improved via contours optimized for sound emissions. The inventive wheel can be used for all types of rail vehicles, such as trams, subways, multiple units, locomotives, and/or wagons.

The material recesses can be implemented during the production of a new wheel, and in addition it is also conceivable for existing wheels to be retrofitted (for example, during maintenance or servicing procedures).

Forming the inventive wheel as a forged wheel further achieves a particular flexibility when implementing contours of the material recess and simplifications in manufacturing with a high quality of manufacture, in particular in comparison to cast wheels.

In order to achieve a quality of a cast component that is high and that also fluctuates only to a negligible extent in series manufacture during a casting process, complex method steps and specific devices are often necessary, as a function of material properties of the component (for example, degassing of a molten mass in a vacuum degassing device). In comparison to a spoked cast wheel the forged wheel with the material recess has comparable advantages in terms of mass, with a significantly safer manufacturing process.

Furthermore, in comparison to forged wheels, cast wheels have a poorer structural and/or surface quality (for example, due to porosities, cavities, etc.), which are also apparent in the finished product or wheel.

It is for example favorable if the wheel web is arranged as the only wheel web on the wheel.

Due to these measures, a reduction in mass is effected in comparison to a wheel with two wheel webs, for example, between which a cavity is arranged.

It is further helpful if at least the first recess and a second recess are arranged in the wheel web. Here, it is helpful if the first recess and the second recess are arranged and formed symmetrically at least with respect to a first wheel front axis.

In a preferred embodiment, a third recess and a fourth recess are arranged in the wheel web. Here, it is favorable if the third recess and the fourth recess are arranged and formed symmetrically at least in respect of a second wheel front axis.

These measures achieve a particularly large reduction in the mass of the wheel without negatively impacting the running properties of the wheel. The tendency of the wheel to oscillate is reduced.

In an advantageous embodiment, the first recess is formed in the shape of a sector of a circular ring, at least in a central section.

Here, it is helpful if an arc length of the first recess, defined by a center radius of the first recess, is greater than an eighth and less than a quarter of a circumference of a circle defined by the center radius. As a result, a high strength of the wheel is effected despite the material recess.

It is further helpful if at least the first recess has at least one first end section formed in the shape of a semicircle. This measure prevents or at least reduces stress concentrations in corners or transitional areas between the first end section and a solid section of the wheel web. Risks relating to crack formation in the inventive wheel due to the material recess are reduced.

A rapid and simple implementation, suitable for series manufacture, of the material recess is achieved if the recessed material is milled out.

A corresponding advantage is also achieved if the recessed material is punched out.

Milling out or punching out material is also possible in the case of forged wheels that are suitable for high wheel loads.

A large reduction in unsprung masses is effected for a chassis for rail vehicles with inventive wheels.

Manufacturing advantages are achieved with a method for producing a wheel for a chassis of a rail vehicle, if during a forging process on a wheel, material is recessed from a wheel web of the wheel. As a result, the need for deformation energy is reduced, because the wheel or a corresponding forged workpiece is easily deformable during the forging process (e.g., due to high processing temperatures) and this easy deformability is also used to recess material from the wheel web.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail in the below drawings using exemplary embodiments, in which:

FIG. 1 shows a layout of an exemplary embodiment of an inventive wheel with four recesses;

FIG. 2 shows a side view of a section from an exemplary embodiment of an inventive chassis with inventive wheels; and

FIG. 3 shows a flow diagram for an exemplary embodiment of an inventive method for producing an inventive wheel by means of forging.

### DETAILED DESCRIPTION OF THE EXEMPLARY EMBODIMENTS

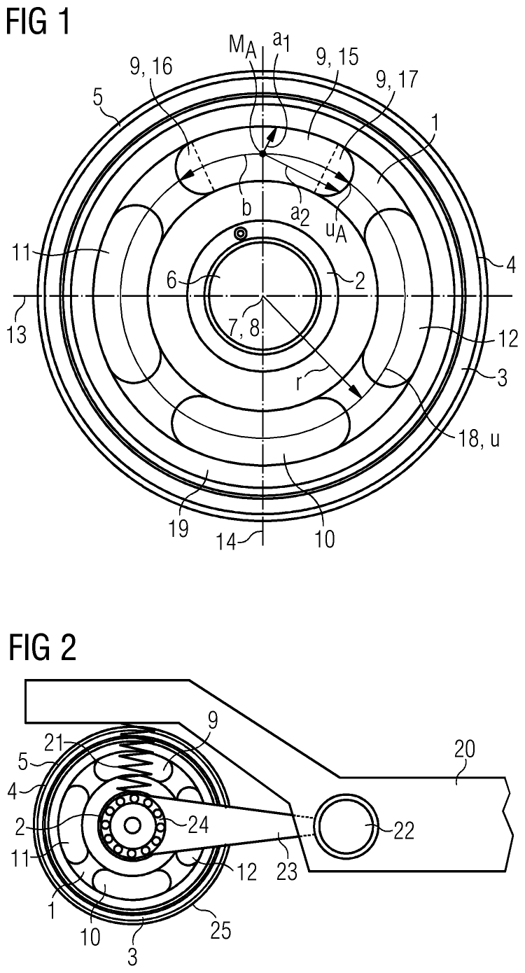

FIG. 1 shows a layout of an exemplary embodiment of an inventive wheel. The wheel, which is a solid wheel and which is formed as a forged wheel made of steel, is provided for a chassis of a rail vehicle, and has a single straight wheel web 1, a wheel hub 2 and a tempered wheel rim 3 with a running surface 4 and a wheel flange 5.

Via a central hole 6 in the wheel hub 2, the wheel can be connected to a wheelset shaft (not shown) of a wheelset or, if the chassis is formed as an idler gear chassis, to an axle stub (not shown) of the idler gear chassis.

By way of the running surface 4 and the wheel flange 5 the wheel can roll on a rail (not shown) of a track.

A forged material of the wheel has a carbon content of less than 0.6%.

In the region of the wheel rim 3, the forged material has an upper yield point of greater than 520 MPa and a tensile strength of greater than 820 MPa.

In the region of the wheel rim 3, an individual value of the notch impact energy of the forged material is greater than 12 J (Charpy U test; at a temperature of 20° C.), an average value of the notch impact energy is more than 17 J (Charpy U test; at a temperature of 20° C.).

In the region of the wheel rim 3, an individual value of the fracture toughness of the forged material is greater than 70 MPa·m^{0.5}, and an average value of the fracture toughness is more than 80 MPa·m^{0.5}. The forged material hence has toughness properties particularly suitable for use in the wheel.

The wheel web 1 is solid in sections. In turn, material is recessed in sections from the wheel web 1, between the wheel hub 2 and the wheel rim 3, extending in the circumferential direction of the wheel web 1, so that the wheel is unbalanced or balanced.

A center of mass 7 of the wheel is arranged in a geometric center point 8 of the wheel, where an axis of rotation of the wheel runs through the center of mass 7 or the geometric center point 8.

Arranged in the wheel web 1 are a first recess 9, a second recess 10, a third recess 11 and a fourth recess 12. Arranged between the first recess 9, the second recess 10, the third recess 11 and the fourth recess 12 and surrounding them are solidly formed sections of the wheel web 1 or of the wheel.

The first recess 9, the second recess 10, the third recess 11 and the fourth recess 12 are arranged symmetrically. As a result, the wheel is unbalanced.

The first recess 9, the second recess 10, the third recess 11 and the fourth recess 12 are arranged and formed symmetrically with respect to a first wheel front axis 13 and a second wheel front axis 14. The first wheel front axis 13 and the second wheel front axis 14 are arranged orthogonally to one another.

In its center section 15 the first recess 9 is formed in the shape of a circular ring sector and has a first end section 16 and a second end section 17, which are arranged adjacent to the center section 15 and are formed as rounded in the shape of a semicircle.

A first distance a₁ and a second distance a₂ between a recess center point M_{A} of the first recess 9 and an edge u_{A} of the first recess 9 differ in size. The first recess 9 is formed as rounded, but not circular.

An arc length b, defined by a center radius r of the first recess 9, of the first recess 9 is greater than an eighth and less than a quarter of a circumference u, defined by the center radius r, of an imaginary circle 18 arranged concentrically to the wheel web 1.

The arc length b of the first recess 9 is around a fifth of the circumference u.

The first recess 9 is arranged radially spaced apart from the wheel hub 2 and adjoins a curve 19, which is formed in a transitional region between the wheel web 1 and the wheel rim 3.

The curve 19 is associated with the wheel web 1. In accordance with the invention, it is also possible for the first recess 9 to protrude into the curve 19 or extend into a rounded section directly adjoining the wheel hub 2, etc.

The first recess 9 is structured to extend over an entire thickness of the wheel web 1. Edges of the first recess 9 that appear projecting in FIG. 1 in the direction of thickness of the wheel web 1 are formed as straight and orthogonal to front faces of the wheel web 1. The first end section 16 and the second end section 17 are hence each formed as semi-cylindrical.

In accordance with the invention, it is also conceivable for the edges of the first recess 9 extending in the direction of thickness of the wheel web 1 to be formed as curved; for example, if the wheel web 1 is designed as corrugated.

The second recess 10, the third recess 11 and the fourth recess 12 are formed identically to the first recess 9 and are positioned radially identically to the first recess 9 in the wheel web 1, but in the circumferential direction have different positions than the first recess 9.

Various three-dimensional geometries can be imagined for the first recess 9, the second recess 10, the third recess 11 and the fourth recess 12. For example, it is conceivable to form the first recess 9, the second recess 10, the third recess 11 and the fourth recess 12 as transverse to radial directions of the wheel web 1 (a radial direction is indicated, for example, by the center radius r), rectangular or trapezoidal with rounded corners, oval or elliptical. For base and top surfaces of the first recess 9, the second recess 10, the third recess 11 and the fourth recess 12 any geometric shapes optimized for wheel mass, wheel strength and/or wheel noise are possible.

The first recess 9, the second recess 10, the third recess 11 and the fourth recess 12, i.e., the recessed material, are milled out with a form milling cutter following a forging process of the wheel via a CNC (Computerized Numerical Control) milling machine (not shown).

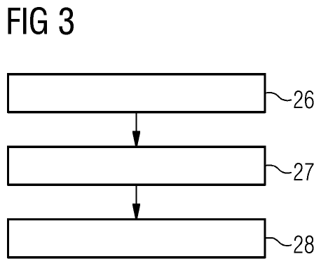

In accordance with the invention, it can, however, also be imagined that the recessed material is punched out. For example, the punching out of the first recess 9, the second recess 10, the third recess 11 and the fourth recess 12 can be performed during the forging process of the wheel, as is described in connection with FIG. 3.

FIG. 2 shows a section from an exemplary embodiment of an inventive chassis of a rail vehicle as a side view, which comprises wheels in accordance with FIG. 1.

The chassis has a chassis frame 20, which is connected to a first wheelset 25 via a first primary spring 21, a first wheelset guide bushing 22, a first swing arm 23 and a first wheelset bearing 24 and, not visible in FIG. 2, via a second primary spring, a second wheelset guide bushing, a second swing arm and a second wheelset bearing.

The chassis frame 20 is further coupled to a second wheelset of the chassis, not shown in FIG. 2, via a third primary spring, a fourth primary spring, a third wheelset guide bushing, a fourth wheelset guide bushing, a third swing arm, a fourth swing arm, a third wheelset bearing and a fourth wheelset bearing, which are likewise not shown in FIG. 2.

A first wheel and a second wheel, not visible in FIG. 2, opposite the first wheel, is connected to a first wheelset shaft, likewise not visible in FIG. 2, of the first wheelset 25.

A third wheel and a fourth wheel of the second wheelset are connected to a second wheelset shaft of the second wheelset.

The first wheel is structured as described in connection with FIG. 1 and comprises a wheel web 1, a wheel hub 2 and a wheel rim 3 with a running surface 4 and a wheel flange 5. A first recess 9, a second recess 10, a third recess 11 and a fourth recess 12 are formed in the wheel web 1.

The second wheel, the third wheel and the fourth wheel are structured identically to the first wheel.

FIG. 3 discloses a flow diagram for an exemplary embodiment of an inventive method for producing a wheel for a chassis of a rail vehicle, as shown by way of example in FIG. 1 and FIG. 2, via a forging process performed as hot forming.

In a heating step 26, a temperature of a forged workpiece made of steel in a furnace is first set to a value of approx. 1000° C., i.e., above a recrystallization temperature. Depending on the type of steel used for the forged workpiece, it is possible to set a temperature in a range between approx. 950° C. and approx. 1250° C.

In a transformation step 27, following on from the heating step 26, for which the temperature of the forged workpiece is kept at approximately 1000° C. or cooling to a temperature of below 950° C. is prevented, a body with a wheel shape is formed from the workpiece, i.e., a wheel web 1, a wheel hub 2 and a wheel rim 3 with a running surface 4 and a wheel flange 5 are produced by formation under pressure in a die.

During the forging process, immediately after the transformation step 27, a first recess 9, a second recess 10, a third recess 11 and a fourth recess 12 are punched out from the wheel web 1 in a punching-out step 28 via a punching tool. The temperature of the forged workpiece or of the wheel has a value of above the recrystallization temperature of steel during the punching-out step 28. For this exemplary embodiment of the inventive method, the temperature is more than 950° C.

After the punching-out step 28, the wheel cools down completely and achieves its strength properties necessary for use in the chassis.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-20. (canceled)

21. A wheel for a chassis of a rail vehicle, comprising:
a wheel web;
a wheel hub; and
a wheel rim with a running surface and a wheel flange;
wherein the wheel is formed as a forged wheel;
wherein material is recessed out of the wheel web, which is solid in sections, between the wheel hub and the wheel rim, in sections extending in the circumferential direction or transversely with respect to a radial direction of the wheel web; and
wherein at least one first distance and one second distance between a recess center point of a first recess in the wheel web and an edge of the first recess differ in size.

22. The wheel as claimed in claim 21, wherein the first recess is formed as rounded.

23. The wheel as claimed in claim 21, wherein the wheel web is arranged as a single wheel web of the wheel.

24. The wheel as claimed in claim 22, wherein the wheel web is arranged as a single wheel web of the wheel.

25. The wheel as claimed in claim 21, wherein a center of mass of the wheel is arranged at least approximately in a geometric center point of the wheel.

26. The wheel as claimed in claim 21, wherein a forged material of the wheel has a carbon content of less than 0.6%.

27. The wheel as claimed in claim 21, wherein a forged material of the wheel has an upper yield point of greater than 520 MPa.

28. The wheel as claimed in claim 21, wherein a forged material of the wheel has a tensile strength of greater than 820 MPa.

29. The wheel as claimed in claim 21, wherein a forged material of the wheel has a notch impact energy of greater than 12 J.

30. The wheel as claimed in claim 21, wherein a forged material of the wheel has a fracture toughness of greater than 70 MPa·m^{0.5}.

31. The wheel as claimed in claim 21, wherein at least the first recess and a second recess are arranged in the wheel web.

32. The wheel as claimed in claim 31, wherein the first recess and the second recess are arranged and formed as symmetrical at least in respect of a first wheel front axis.

33. The wheel as claimed in claim 31, wherein a third recess and a fourth recess are arranged in the wheel web.

34. The wheel as claimed in claim 32, wherein a third recess and a fourth recess are arranged in the wheel web.

35. The wheel as claimed in claim 33, wherein the third recess and the fourth recess are arranged and formed symmetrically at least with respect to a second wheel front axis.

36. The wheel as claimed in claim 21, wherein at least the first recess is formed at least in a center section in the shape of a circular ring sector.

37. The wheel as claimed in claim 36, wherein an arc length), defined by a center radius of the first recess, of the first recess is established to be greater than an eighth and less than a quarter of a circumference, defined by the center radius of a circle.

38. The wheel as claimed in claim 21, wherein at least the first recess has at least one first end section formed as semicircular.

39. The wheel as claimed in claim 21, wherein the recessed material is milled out.

40. The wheel as claimed in claim 21, wherein the recessed material is punched out.

41. A chassis for rail vehicles with wheels as claimed in claim 21.

42. A method for producing a wheel for a chassis of a rail vehicle, the wheel comprising a wheel web, a wheel hub and a wheel rim with a running surface and a wheel flange, the method comprising:
forging the wheel; and
recessing material out of the wheel web;
wherein material is recessed out of the wheel web, which is solid in sections, between the wheel hub and the wheel rim, in sections extending in the circumferential direction or transversely with respect to a radial direction of the wheel web; and
wherein at least one first distance and one second distance between a recess center point of a first recess in the wheel web and an edge of the first recess differ in size.
